(19) United States
(12) Patent Application Publication
(10) Pub. No.: US 2022/0318664 A1
(43) Pub. Date: Oct. 6, 2022

(54) SYSTEM AND METHOD FOR PATTERN GENERATION USING QUANTUM COMPUTING

(71) Applicant: Zensar Technologies Limited, Pune (IN)

(72) Inventors: Sridhar Gadi, Pune (IN); Manish Kumar, Pune (IN); Pavan Jakati, Pune (IN); Ankit Gupta, Pune (IN)

(21) Appl. No.: 17/643,317

(22) Filed: Dec. 8, 2021

(30) Foreign Application Priority Data
Mar. 31, 2021 (IN) 202121015034

(51) Int. Cl. G06N 10/80; G06K 9/62; G06F 17/15

(52) U.S. Cl. CPC G06N 10/80; G06K 9/6215; G06F 17/15

(57) ABSTRACT

The present disclosure describes a method and system for generating at least one pattern from at least one data set using quantum computing. The system comprises at least one quantum processor; and at least one non-quantum processor operatively coupled to the at least one quantum processor and configured to process the at least one data set to generate at least one first intermediary pattern comprising at least one first keyword and transmit the generated pattern(s) to the quantum processor(s). The quantum processor(s) is configured to receive the data set(s) and the first intermediary pattern(s); process the data set(s) to generate at least one second intermediary pattern and at least one corresponding metadata; and process the first intermediary pattern(s) and the at least one second intermediary pattern(s) to generate the at least one final pattern.

### TECHNICAL FIELD

The present disclosure generally relates to the field of data mining. Particularly, the present disclosure relates to a system and a method for pattern generation using quantum computing.

### BACKGROUND

In the field of computing, a pattern is a regularity or similarity in data and pattern recognition is a process of finding regularities and similarities in the data. Pattern recognition has various applications in statistical data analysis, signal processing, image processing, information retrieval, disease categorization, bioinformatics, data compression, computer graphics, machine learning, etc. Due to the vast applications of pattern recognition, it becomes necessary to recognize patterns in the data in an effective way.

Much progress has been made in the field of pattern recognition. Various techniques and models have been developed for processing the data to recognize patterns. These techniques are implemented with the help of classical computing systems. The classical computing systems use a specific logic (binary logic) to carry out their operations. Binary logic is a form of algebra where a value is either True or False i.e., 1 or 0, respectively. Thus, the classical computing systems process data in the form of bits 0 and 1, which often restricts the capability to process and drive intelligence from the data in real time.

Moreover, in recent times, the amount of data generated has exploded because of technology advancements. Due to the huge amount of data, it becomes impossible for the classical computing systems to generate patterns from data in real time. Moreover, the computations using the classical computing systems are highly resource intensive and costly.

With the huge and rapidly growing amount of data that needs to be processed, there is a need for further improvement in the technology, especially for systems that are cheaper and consume fewer computing resources and that can generate patterns in real time even for huge amount of data.

Conventionally, there are no techniques available in the market that can address the above-identified problems. Hence, there exists a need for the technology that facilitates real-time identification of patterns from data.

The information disclosed in this background section is only for enhancement of understanding of the general background of the invention and should not be taken as an acknowledgement or any form of suggestion that this information forms the prior art already known to a person skilled in the art.

### SUMMARY

One or more shortcomings discussed above are overcome, and additional advantages are provided by the present disclosure. Additional features and advantages are realized through the techniques of the present disclosure. Other embodiments and aspects of the disclosure are described in detail herein and are considered a part of the disclosure.

An object of the present disclosure is to effectively utilize fast-processing capabilities of quantum computing systems for processing huge volume of data.

Another objective of the present disclosure is to process huge volume of data using quantum computing systems to generate accurate patterns in real time.

The above stated objects as well as other objects, features, and advantages of the present disclosure will become clear to those skilled in the art upon review of the following description, the attached drawings, and the appended claims.

According to an aspect of the present disclosure, methods and systems are provided for generating patterns from one or more data sets.

In a non-limiting embodiment of the present disclosure, the present application discloses a method of generating at least one pattern from at least one data set. The method may comprise receiving, by at least one non-quantum processor and at least one quantum processor, the at least one data set. The method may further comprise processing, by the at least one non-quantum processor, the at least one data set to generate at least one first intermediary pattern comprising at least one first keyword. The method may further comprise processing, by the at least one quantum processor, the at least one data set to generate at least one second intermediary pattern and at least one corresponding metadata. The method may further comprise transmitting, by the at least one non-quantum processor, the generated at least one first intermediary pattern to the at least one quantum processor. The method may further comprise processing, by the at least one quantum processor, the at least one first intermediary pattern and the at least one second intermediary pattern to generate the at least one pattern. The processing the at least one first intermediary pattern and the at least one second intermediary pattern to generate the at least one pattern may comprise mapping the at least one first keyword of the at least one first intermediary pattern with the at least one metadata corresponding to the at least one second intermediary pattern to identify at least one correlation between the at least one first intermediary pattern and the at least one second intermediary pattern. The processing the at least one first intermediary pattern and the at least one second intermediary pattern may further comprise grouping one or more of the at least one first intermediary pattern with one or more of the at least one second intermediary pattern to generate the at least one pattern based on the at least one correlation

In another non-limiting embodiment of the present disclosure, the present application discloses a system for generating at least one pattern from at least one data set. The system may comprise at least one quantum processor and at least one non-quantum processor operatively coupled to the at least one quantum processor. The at least one non-quantum processor may be configured to receive the at least one data set and process the at received least one data set to generate at least one first intermediary pattern comprising at least one first keyword. The at least one non-quantum processor may be further configured to transmit the generated at least one first intermediary pattern to the at least one quantum processor. The at least one quantum processor may be configured to receive the at least one data set and receive the at least one first intermediary pattern. The at least one quantum processor may be further configured to process the at least one data set to generate at least one second intermediary pattern and at least one corresponding metadata. The at least one quantum processor may be further configured to process the at least one first intermediary pattern and the at least one second intermediary pattern to generate the at least one pattern by: mapping the at least one first keyword of the at least one first intermediary pattern with the at least one metadata corresponding to the at least one second intermediary pattern to identify at least one correlation between the at least one first intermediary pattern and the at least one second intermediary pattern; and grouping one or more of the at least one first intermediary pattern with one or more of the at least one second intermediary pattern to generate the at least one pattern based on the at least one correlation.

The present disclosure demonstrates how the increasing volume of data can be processed in real time using quantum computing systems. The present disclosure can do a fast processing of data and may provide more accurate patterns in real time. Therefore, the present disclosure effectively utilizes the fast-processing capabilities of quantum computing systems for processing huge volume of data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

Further aspects and advantages of the present disclosure will be readily understood from the following detailed description with reference to the accompanying drawings. Reference numerals have been used to refer to identical or functionally similar elements. The figures together with a detailed description below, are incorporated in and form part of the specification, and serve to further illustrate the embodiments and explain various principles and advantages, in accordance with the present disclosure wherein:

FIG. 1 shows an exemplary environment of a communication system 100 for generating patterns from data sets, in accordance with some embodiments of the present disclosure;

FIG. 2 shows a block diagram 200 of the communication system 100 illustrated in FIG. 1, in accordance with some embodiments of the present disclosure;

FIG. 3 shows a process flow diagram 300 for generating patterns from data sets, in accordance with some embodiments of the present disclosure.

FIGS. 4(a) and 4(b) show examples illustrating the implementation of the disclosed techniques, in accordance with some embodiments of the present disclosure.

FIG. 5 shows a block diagram 500 of a non-quantum computing system 110, in accordance with some embodiments of the present disclosure.

FIG. 6 shows block diagram 600 of a quantum computing system 120, in accordance with some embodiments of the present disclosure.

FIG. 7 depicts a flowchart 700 illustrating a method of generating patterns from data sets, in accordance with some embodiments of the present disclosure.

It should be appreciated by those skilled in the art that any block diagrams herein represent conceptual views of the illustrative systems embodying the principles of the present disclosure. Similarly, it will be appreciated that any flowcharts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present disclosure described herein as “exemplary” is not necessarily to be construed as preferred or advantageous over other embodiments.

While the disclosure is susceptible to various modifications and alternative forms, specific embodiments thereof have been shown by way of example in the drawings and will be described in detail below. It should be understood, however, that it is not intended to limit the disclosure to the particular form disclosed, but on the contrary, the disclosure is to cover all modifications, equivalents, and alternatives falling within the spirit and the scope of the disclosure.

The terms “comprise(s)”, “comprising”, “include(s)”, or any other variations thereof, are intended to cover a non-exclusive inclusion, such that a setup, device, apparatus, system, or method that comprises a list of components or steps does not include only those components or steps but may include other components or steps not expressly listed or inherent to such setup or device or apparatus or system or method. In other words, one or more elements in a device or system or apparatus proceeded by “comprises . . . a” does not, without more constraints, preclude the existence of other elements or additional elements in the system.

The terms like “pattern generation” and “pattern recognition” may be used interchangeably throughout the description. Further, the terms like “non-quantum computing system” and “classical computing system” may be used interchangeably or in combination throughout the description. Further, the terms like “at least one” and “one or more” may be used interchangeably throughout the description. Furthermore, the terms like “a plurality of” and “multiple” may be used throughout the description. Furthermore, the terms like “at least one pattern” and “at least one final pattern” may be used interchangeably throughout the description.

In the following detailed description of the embodiments of the disclosure, reference is made to the accompanying drawings that form a part hereof, and in which are shown by way of illustration of specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense. In the following description, well known functions or constructions are not described in detail since they would obscure the description with unnecessary detail.

The present disclosure provides techniques (methods and systems) for generating at least one pattern from at least one data set. Pattern generation is the process of recognizing regularities/similarities in the at least one data set by a machine. Conventionally, the machines used are classical computing systems. However, due to the huge amount of data, it becomes impossible for the classical computing systems to generate patterns in real time because classical computing systems are binary computing systems where information is encoded in binary “bits” that can be either 0 or 1.

Thus, although much progress has been made in pattern generation systems, with the huge and rapidly growing amount of data there is a need for further improvement, especially for systems that can handle a large quantity of data for generating patterns in real time using minimum resources. Moreover, the system should use minimum resources while performing the computations.

To overcome these and other problems, the present disclosure proposes techniques that utilize the fast-processing capabilities of quantum computing systems for pattern generation. Quantum computing systems use the properties of quantum physics to store data and to perform computations. Thus, the quantum computing systems can vastly outperform even the best classical supercomputing machines.

The basic unit of memory in a quantum computing system is a ‘quantum bit’ or ‘qubit’. Qubits may represent 0 state, 1 state, and a mixed state, called a “superposition” where both 1 and 0 exists at the same time. Thus, the quantum computing systems may be in many different states all at once. Hence, a series of qubits can represent different things simultaneously. For example, four bits are enough for a classical computing system to represent any number between 0 and 16. But using four qubits, a quantum computing system can represent every number between 0 and 16 at the same time. This is where quantum computing systems get their edge over classical computing systems.

However, there may also be situations where classical computing systems still outperform quantum computing systems. So, the computing system of future may be a combination of both quantum computing system and classical computing system.

The present disclosure proposes a system which utilizes both classical computing system and quantum computing system for generating patterns from data sets in real time.

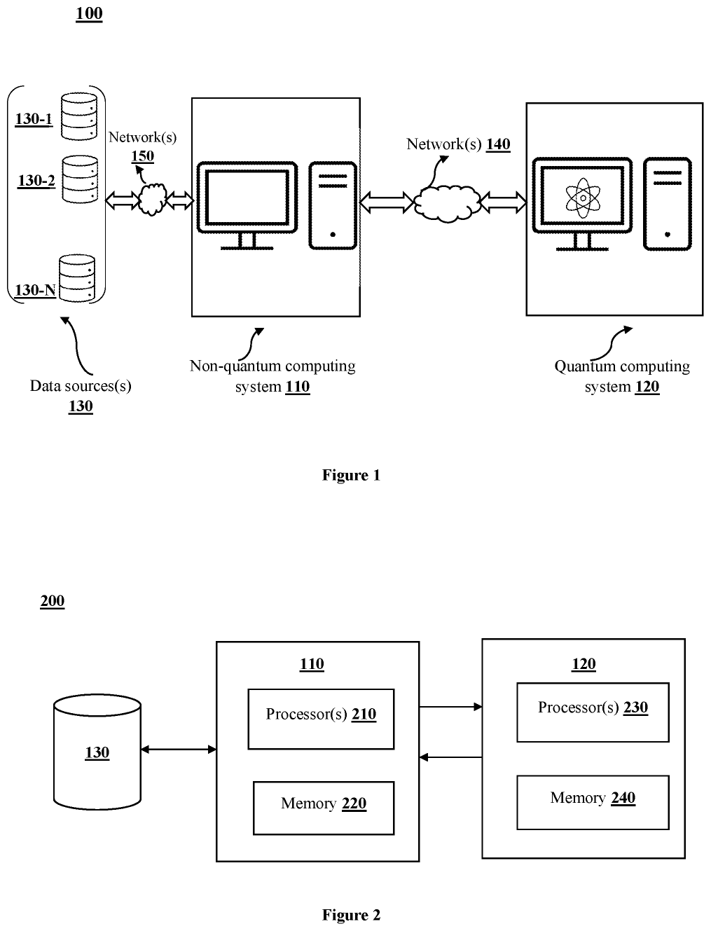

Referring now to FIG. 1, which illustrates a communication system 100 for use in pattern generation, in accordance with some embodiments of the present disclosure. The communication system 100 may comprise a non-quantum computing system 110 which is in communication with one or more data sources 130-1, 130-2 . . . 130-N via at least one network 150. The one or more data sources 130-1, 130-2 . . . 130-N may be collectively represented by reference numeral 130. The communication system 100 may also comprise a quantum computing system 120 which is in communication with the non-quantum computing system 110 via at least one network 140.

The networks 140, 150 may comprise a data network such as, but not restricted to, the Internet, Local Area Network (LAN), Wide Area Network (WAN), Metropolitan Area Network (MAN), etc. In certain embodiments, the networks 140, 150 may include a wireless network, such as, but not restricted to, a cellular network and may employ various technologies including Enhanced Data rates for Global Evolution (EDGE), General Packet Radio Service (GPRS), Global System for Mobile Communications (GSM), Internet protocol Multimedia Subsystem (IMS), Universal Mobile Telecommunications System (UMTS) etc. In one embodiment, the networks 140, 150 may include or otherwise cover networks or subnetworks, each of which may include, for example, a wired or wireless data pathway.

The at least one data source 130 may be any data source comprising huge volumes of data and/or information. The at least one data source 130 may be any public or private data source such as, but not limited to, banking records, IoT logs, computerized medical records, online shopping records, chat data of users stored on servers, even logs of computing devices, vulnerability databases etc. The non-quantum computing system 110 may fetch at least one data set from the at least one data source 130. The at least one data set may be in any form such as, but not limited to, log data.

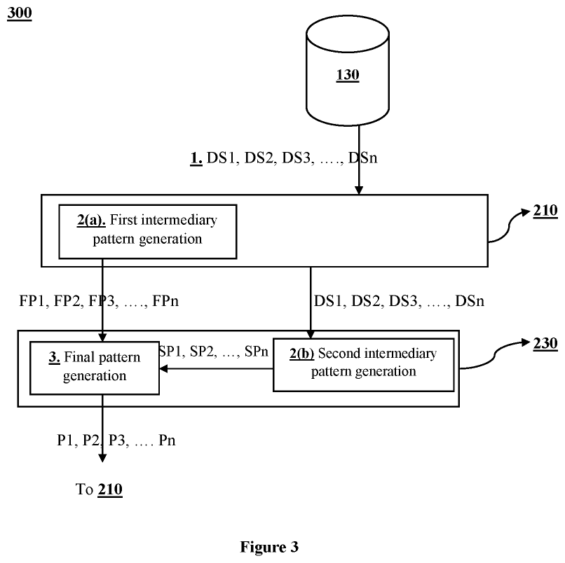

Now, FIG. 1 is explained in conjunction with FIG. 2. FIG. 2 shows a block diagram 200 of the communication system 100 in accordance with some embodiments of the present disclosure. According to an embodiment of the present disclosure, the communication system 100 may comprise the non-quantum computing system 110, the quantum computing system 120, and the at least one data source 130. The non-quantum computing system 110 may comprise at least one non-quantum processor 210 and at least one memory 220. Similarly, the quantum computing system 120 may comprise at least one quantum processor 230 and at least one memory 240.

The non-quantum processor 210 may include, but not restricted to, a general-purpose processor, an Application Specific Integrated Circuit (ASIC), a Digital Signal Processor (DSP), microprocessors, microcomputers, micro-controllers, digital signal processors, central processing units, state machines, logic circuitries, and/or any devices that manipulate signals based on operational instructions.

The quantum processor 230 may include, but not restricted to, quantum circuits and quantum logic gates. The quantum processor 230 may use qubits for data processing.

The memory 220 may be communicatively coupled to the at least one non-quantum processor 210 and the memory 240 may be communicatively coupled to the at least one quantum processor 230 The memory 220, 240 may comprise various instructions, one or more data sets, and one or more patterns. The memory 220, 240 may include a Random-Access Memory (RAM) unit and/or a non-volatile memory unit such as a Read Only Memory (ROM), optical disc drive, magnetic disc drive, flash memory, Electrically Erasable Read Only Memory (EEPROM), a memory space on a server or cloud and so forth.

The communication system 100 proposed in present disclosure may be named as a Log Pattern Formalism using Quantum System (LPFQ system) which may fetch at least one set of data from the at least one data source 130, extract and find meaningful insights from the received data, and display the extracted insights. The LPFQ system may work in two phases-Phase 1 and Phase 2. The Phase 1 may be implemented on the non-quantum computing system 110 and the Phase 2 may be implemented on the quantum computing system 120. Final output may be a combined result of Phase 1 and Phase2. It may be worth noting here that the computations in Phase 1 and Phase 2 may be performed parallelly in order to reduce time and provide the final output faster.

In one non-limiting embodiment of the present disclosure, the at least one non-quantum processor 210 may receive/extract, via the at least one network 150, at least one data set from the at least one data source 130. In one non-limiting embodiment, the data sets may arrive continuously from the at least one data source 130 at the non-quantum processor 210. The at least one data set received at the non-quantum processor 210 may include various type of data.

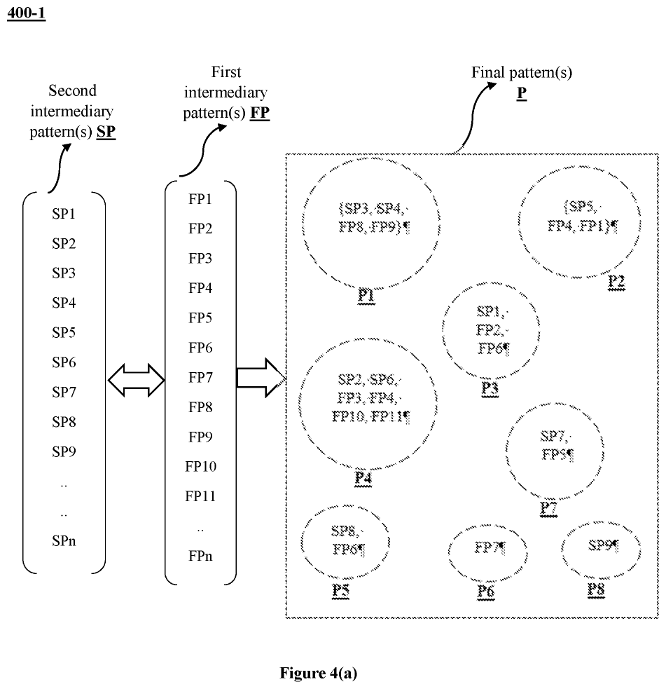

Immediately after receiving the at least one data set, the non-quantum processor 210 may transmit the received at least one data set to the quantum processor 230 which may start processing the received at least one data set. The non-quantum processor 210 may also start processing the received at least one data set. In another non-limiting embodiment of the present disclosure, the at least one quantum processor 230 may receive/extract, via the at least one network 140, at least one data set from the at least one data source 130. The processing of the at least one data set at the quantum processor 230 and the non-quantum processor 210 is described below with the help of a process flow diagram 300 as described in FIG. 3.

In Step 1 of the process flow diagram 300, at least one data set may be received at the at least one non-quantum processor 210 from the at least one data source 130. The at least one data set may comprise one or more datasets collectively represented as DS.

DS={DS1,DS2,DS3, . . . ,DSn}.

Consider an example where the datasets have following contents:
DS1={‘quantum’, ‘mechanics’, ‘is’, ‘a’, ‘concept’, ‘of’, ‘mechanics’}
DS2={‘a’, ‘quantum’, ‘computer’, ‘to’, ‘factor’, ‘an’, ‘integer’, ‘Shor's’, ‘algorithm’, ‘runs’, ‘in’, ‘polynomial’, ‘time’}
DS3={‘quantum’, ‘computer’, ‘with’, ‘a’, ‘sufficient’, ‘number’, ‘of’, ‘qubits’, ‘could’, ‘operate’, ‘faster’}

Usually, the data gathered from the different data sources is raw data and is not feasible for analysis. Before such data can be passed for pattern generation, the data needs some clean-up or pre-processing so that the system may focus on important key features instead of key features which add minimal or no value. The pre-processing may include one or more operations comprising: removing stop words, removing numbers, removing special characters, expanding contractions, removing punctuations, stemming, lemmatization, removing extra white spaces etc., but not limited thereto. In one non-limiting embodiment of the present disclosure, removing the stop words may include removing numbers, removing special characters, expanding contractions, removing punctuations, stemming, lemmatization, removing extra white spaces etc., but not limited thereto. The pre-processing improves accuracy of the pattern generation techniques. The at least one processed data set may be collectively represented as PDS:

PDS={PDS1,PDS2,PDS3, . . . ,PDSn}

The processed version of at least one dataset may look like:
PDS1={‘quantum’, ‘mechanics’, ‘concept’, ‘mechanics’}
PDS2={‘quantum’, ‘computer’, ‘factor’, ‘integer’, ‘Shoes’, ‘algorithm’, ‘runs’, ‘polynomial’, ‘time’}
PDS3={‘quantum’, computer’, ‘sufficient’, ‘number’, ‘qubits’, ‘operate’, ‘faster’}
   The number of items in a processed dataset may be represented by a character N. The at least one processed data set may then be utilized for generation of at least one first intermediary pattern. Each of the at least one processed data set may comprise one or more keywords.

In Step 2(a) of the process flow diagram 300, the at least one non-quantum processor 210 may generate at least one first intermediary pattern from the at least one processed data set. The at least one non-quantum processor 210 may define or retrieve a set which may have zero or more predefined keywords. The predefined keywords may be user defined keywords for pattern validation. The set of zero or more predefined keywords may be represented as set S. Assuming the zero or more predefined keywords as ‘quantum’ and ‘factor’, the set S may look like:

S={‘quantum’,‘factor’}

The at least one non-quantum processor 210 may sequentially process each one of the at least one processed data set to populate the set S with data present in the at least one processed data set. A variable count may be defined for each keyword which may count an occurrence of the keyword in the set S and in the one or more processed datasets (PDS). It is assumed here that the zero or more predefined keywords present in the set S are unique and the count of each one of the zero or more predefined keywords is 1 by default. In one non-limiting embodiment, the set S may be a multidimensional set comprising keywords and their count. In another non-limiting embodiment, the set S may comprise only keywords and the count of keywords present in set S may be stored in a separate array A.

In one non-limiting embodiment of the present disclosure, for processing a processed data set (say for e.g., PDS1), the at least one non-quantum processor 210 may initially select a keyword from the processed data set (PDS1) and may compare the selected keyword with the predefined keywords present in the set S. If the selected keyword is not present in the set S, the at least one non-quantum processor 210 may add/insert the selected keyword in the set S and may set the count of the selected keyword as 1. However, if the selected keyword is already present in the set S, the at least one non-quantum processor 210 may not add the selected keyword in the set S and may simply increment a count of the selected keyword by one. In one non-limiting embodiment of the present disclosure, the at least one non-quantum processor 210, after incrementing the count of the selected keyword, which is already present in the set S, may sort the set S in decreasing order of the counts of the keywords present in the set S.

In one non-limiting embodiment of the present disclosure, the at least one non-quantum processor 210 may perform the operations of paragraph [0050] for each keyword present in the processed data set (PDS1).

In one non-limiting embodiment of the present disclosure, the at least one non-quantum processor 210 may perform the processing described paragraphs [0050-0051] for each one of the at least one processed data set (PDS). Finally, after performing the processing for each of the at least one processed data set (PDS), the at least one non-quantum processor 210 may output final set S.

It may be worth noting here that for the sake of simplicity the above explanation is described by considering the data present inside set S and inside the processed data sets (PDS) as keywords. It may be understood to a person skilled in art that the present disclosure is not limited thereto and the data present inside the set S and the processed data sets (PDS) may be in any form such as key strings, sequences, patterns, clusters, and like.

In one non-limiting embodiment of the present disclosure, the final set S may correspond to the at least one first intermediary pattern comprising at least one first keyword sorted according to the count of the at least one keyword. It may be understood to a person skilled in art that the first intermediary pattern is not limited to keywords and may be in the form of a key string or a cluster, or a combination thereof. The at least one first keyword is unique in the at least one processed data set and the set S. The at least one first intermediary pattern generated by the at least one non-quantum processor 210 may be represented collectively as FP.

FP={FP1,FP2,FP3, . . . ,FPn}

The at least one first intermediary pattern (FP) may be transmitted to the at least one quantum processor 230.

In a Step 2(b) of the process flow diagram 300, the at least one quantum processor 230 may also generate at least one second intermediary pattern from the at least one data set (DS) received from the at least one non-quantum processor 210. The at least one quantum processor 230 may use predefined libraries (such as Log Mine, Log PAI, LogCluster, Log 3C etc., but not limited thereto) for processing the at least one data set (DS) to generate the at least one second intermediary pattern. The at least one second intermediary pattern may be collectively represented as SP:

SP={SP1,SP2,SP3, . . . ,SPn}

The at least one quantum processor 230 with the help of predefined libraries may also generate at least one metadata corresponding to the generated at least one second intermediary pattern (SP). The at least one metadata may provide information about the data present inside the at least one second intermediary pattern. For the sake of explanation, it is assumed that the at least one metadata comprises at least one second keyword. However, the present disclosure is not limited thereto and the at least one metadata may comprise keywords, key strings, characters, clusters, and like. It may be understood to a person skilled in art that the second intermediary pattern is not limited to keywords and may be in the form of a key string or a cluster, or a combination thereof.

It may be worth noting here that the processing of at least one data set, by the at least one non-quantum processor 210, to generate the at least one first intermediary pattern and the processing of at least one data set, by the at least one quantum processor 230, to generate the at least one second intermediary pattern are performed simultaneously (i.e., in parallel). In other words, the steps 2(a) and 2(b) are performed simultaneously. Thus, the parallel processing at the quantum and non-quantum processors saves overall time of pattern generation.

As described above, the at least one first intermediary pattern (FP) may comprise the at least one first keyword. Further, the at least one second intermediary pattern (SP) may comprise the at least one metadata corresponding to the at least one second intermediary pattern and the at least one metadata may comprise the at least one second keyword.

In one non-limiting embodiment of the present disclosure, the at least one quantum processor 230 may process the at least one first intermediary pattern (FP) and the at least one second intermediary pattern (SP) to generate at least one pattern, as per Step 3 of FIG. 3. For generating the at least one pattern, the at least one quantum processor 230 may map the at least one first keyword of the at least one first intermediary pattern (FP) with the at least one metadata of the at least one second intermediary pattern (SP). For mapping, the at least one quantum processor 230 may extract the at least one second keyword from the at least one metadata. In one non-limiting embodiment, the at least one quantum processor 230 may use Term frequency-inverse document frequency (TF-IDF) and scikit-learn library for extracting keywords from the at least one metadata. After extracting, the at least one quantum processor 230 may map the at least one first keyword with the at least one second keyword. Based on the mapping the at least one first keyword with the at least one second keyword, the at least one quantum processor 230 may identify at least one correlation between the at least one first intermediary pattern (FP) and the at least one second intermediary pattern (SP). Based on the at least one correlation, the at least one quantum processor 230 may group one or more patterns of the at least one first intermediary pattern (FP) with one or more patterns of the at least one second intermediary pattern (SP) to generate the at least one pattern. As described above, the keywords in the at least one first intermediary pattern (FP) are sorted based on their count. This sorting of the keywords may ensure that the keywords having higher count are mapped first. The at least one quantum processor 230 may use natural language processing (NLP) techniques for generating the at least one pattern by processing the at least one first intermediary pattern (FP) and the at least one second intermediary pattern (SP). In other words, the mapping of the at least one first keyword with the at least one second keyword for determining the at least one correlation may be performed by NLP techniques. NLP may use Natural-language understanding (NLU) to understand meaning or the intent behind a keyword for the purpose of mapping.

In one non-limiting embodiment of the present disclosure, the at least one quantum processor 230 may map only those keywords of the at least one first intermediary pattern whose count is greater than a predefined threshold value.

In a non-limiting embodiment of the present disclosure, the at least one quantum processor 230, using the NLP techniques, may identify similarities among different patterns of the at least one first and second intermediary patterns and may group similar patterns into one or more groups. The measure of similarity may be qualitative and/or quantitative. In qualitative, the assessment is done against subjective criteria such as theme, sentiment, overall meaning, etc. while in the quantitative, numerical parameters such as length of the document, number of keywords, common keywords, etc. are compared. Using the qualitative and/or quantitative assessment, the at least one quantum processor 230 may build a similarity matrix which may be used to group similar patterns into the same group to generate the at least one final pattern. The at least one final pattern may be collectively represented as P:

P={P1,P2,P3, . . . ,Pn}

Mapping of the most relevant keywords in the first intermediary patterns with the second intermediary patterns improves the accuracy of the final patterns (P) and reduces the time of pattern generation.

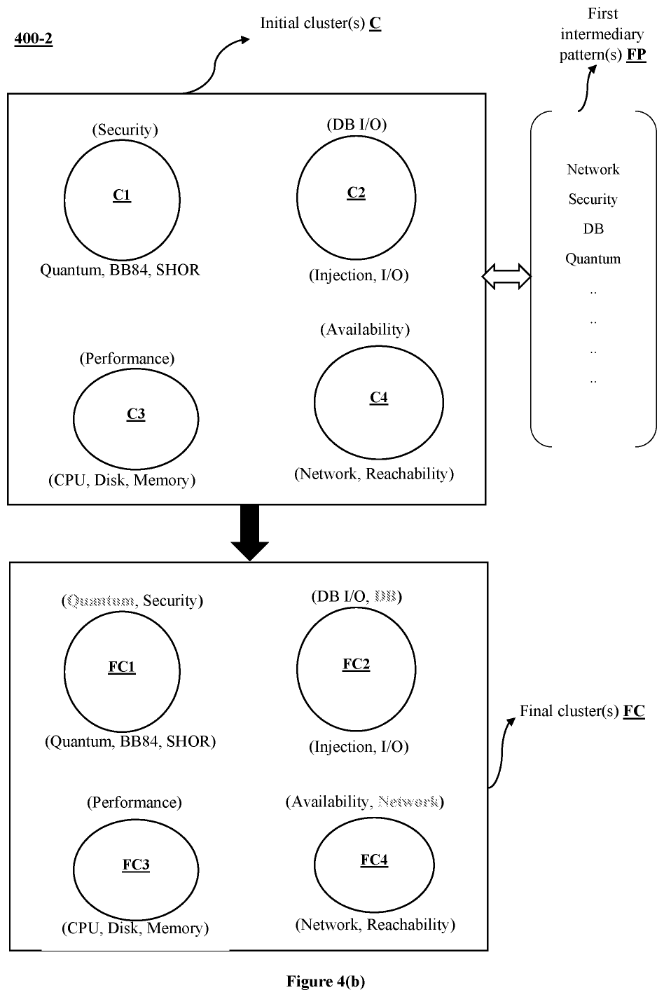

The generation of the at least one final pattern (P) is now explained using an example 400-1 as illustrated in FIG. 4(a). Consider that the at least one first intermediary pattern (FP), the at least one second intermediary pattern (SP), and at least one final pattern (P) comprise:

FP={FP1,FP2,FP3,FP4,FP5,FP6,FP7,FP8,FP9,FP10,FP11, . . . ,FPn}

SP={SP1,SP2,SP3,SP4,SP5,SP6,SP7,SP8,SP9,SP10, . . . ,SPn}

P={P1,P2,P3,P4,P5,P6,P7,P8, . . . ,Pn}

The at least one quantum processor 230 may process the at least one first intermediary pattern (FP) and the at least one second intermediary pattern (SP) and may generate the at least one pattern (P) based on correlation/similarity among the first and second intermediary patterns, as illustrated in FIG. 4(a). For example, the at least one quantum processor 230 after establishing that patterns SP3, SP4, FP8, and FP9 are correlated, may group them together to form pattern P1. It may be worth noting here that if a pattern has correlation with more than one patterns and the more than one patterns are not correlated with each other, then the at least one quantum processor 230 may add the pattern into the more than one groups. For example, pattern FP6 has a correlation with SP8 and (SP1, FP2) but SP8 and (SP1, FP2) are not correlated with each other. So, FP6 has been grouped in two different patterns P3 and P5. Also, if any pattern does not have any correlation with any of the other patterns, it may be kept in separate group (e.g., FP7 and SP9). In one embodiment, one or more patterns when grouped together may form a pattern. In another embodiment, a group comprising one or more patterns may be named as a cluster.

In one non-limiting embodiment of the present disclosure, the at least one quantum processor 230 may generate at least one second intermediary pattern in the form at least one cluster. The at least one cluster may be collectively represented as C:

C={C1,C2,C3, . . . ,Cn}

The at least one quantum processor 230 may also generate at least one metadata corresponding to the at least one cluster (C). The at least one metadata may be collectively represented as MC.

MC={MC1,MC2,MC3, . . . ,MCn},

where MCn denotes the metadata of nth cluster.

The at least one quantum processor 230 may then correlate the at least one first intermediary pattern (FP) with the at least one metadata of the at least one cluster and may allocate the at least one first intermediary pattern (FP) into the at least one cluster (C) based on the correlation to generate at least one final cluster, as illustrated in FIG. 4(b). In this embodiment, the at least one final cluster may refer to the at least one final pattern (P). The at least one final cluster may be collectively represented as FC:

FC={FC1,FC2,FC3, . . . ,FCn}

Referring now to FIG. 4(b), which illustrates an example 400-2 showing the generation of the at least one final cluster (FC) i.e., at least one final pattern (P). Consider that the at least one first intermediary pattern (FP) and the at least one metadata (MC) corresponding to the at least one cluster (C) comprises following data.
FP={quantum, security, DB I/O, network}
MC1={BB84, SHOR}
MC2={Injection, I/O}
MC3={CPU, Disk, Memory}
MC4={Network, reachability}
   The metadata of a cluster (MC) may be indicative of data/information present in a cluster and may comprise the at least one second keyword. For example, the metadata MC1 may indicate that the cluster C1 may comprise data corresponding to security algorithms. Here, the at least one first keyword is ‘quantum’, ‘security’, ‘DB I/O’, ‘network’ and the at least one second keyword is ‘BB84’, ‘SHOR’, ‘injection’, ‘I/O’, ‘CPU’, ‘disk’, ‘memory’, ‘network’, ‘reachability’. Each cluster may have predefined tags associated with it. For example, cluster C1 is tagged as ‘security’, cluster C2 is tagged as ‘DB’, cluster C3 is tagged as ‘performance’, and cluster C4 is tagged as ‘availability.’ These tags may be assigned by the at least one quantum processor 230 or may be assigned manually.

Once the at least one cluster (C) and the at least one first intermediary pattern (FP) have been generated, the at least one quantum processor 230 may process the at least one first intermediary pattern (FP) and the at least one cluster (C) to generate the at least one final cluster (FC) i.e., the at least one final pattern (P). For example, the at least one quantum processor 230 may correlate the at least one first keyword of the at least one first intermediary pattern (FP) with the at least one metadata of the at least one cluster and based on the correlation, the at least one quantum processor 230 may allocate the at least one first intermediary pattern (FP) into the at least one cluster (C) to generate the at least one final cluster (FC).

For example, the at least one quantum processor 230 may select a keyword ‘security’ from the at least one first intermediary pattern (FP) and may correlate the selected keyword with the metadata of the at least one cluster (C1, C2, C3, C4). The at least one quantum processor 230 may find that the keyword ‘quantum’ is correlated with cluster C1 because the keywords ‘BB84’ and SHOR′ present inside the metadata of cluster C1 indicates that cluster C1 may have data corresponding to quantum systems. Thus, the at least one quantum processor 230 may tag the keyword ‘quantum’ with the cluster C1. Similarly, for keyword ‘DB’ of the at least one first intermediary pattern (FP), the at least one quantum processor 230 may determine that the keyword ‘DB’ is correlated with cluster C2 because the metadata of cluster C2 relates to databases. Based on this correlation, the at least one quantum processor 230 may tag the keyword ‘DB’ with the cluster C2.

This way the at least one quantum processor 230 may tag all keywords of the at least one first intermediary pattern (FP) into the at least one cluster (C) to generate at least one final cluster (FC) or final pattern. It may be noted here that a single keyword of the at least one first intermediary pattern may be tagged into more than one clusters based on the correlation.

In one non-limiting embodiment of the present disclosure, the at least one quantum processor 230 may transmit the generated at least one cluster and/or pattern to the at least one non-quantum processor 210 via the network 140. The at least one non-quantum processor 210 may display the received patterns on a display. The at least one pattern may be used for understanding the at least one data set and for data analysis. Since, the computation power of quantum processors is very fast, the pattern generation takes place very fast and in real time.

In one non-limiting aspect of the present disclosure, the quantum computing system 120 and the non-quantum computing system 110 may be assigned an optimal number of resources for computations. For example, the non-quantum computing system 110 may be assigned an optimal number of resources using techniques such as, but not limited to Classical Annealing.

In one non-limiting embodiment of the present disclosure, the quantum computing system 110 may also be assigned an optimal number of resources for performing computations. For example, an objection function may be formulated. An objective function is a mathematical expression defining the energy of the communication system, which is used to minimize a loss function. The objective function is a function that has to be minimized in order to find the best solution from a set of possible solutions (i.e., in order to assign an optimal number of resources to the quantum computing system 120). Minimizing the objective function may comprise mapping the objective function to a quadratic unconstrained binary optimization (QUBO).

The QUBO is a combinatorial optimization problem with a wide range of applications including machine learning. The QUBO has two ways to minimize the objective function namely Adiabatic Quantum Computation (AQC) or Quantum Annealing (QA). Quantum annealing (which also includes adiabatic quantum computation) is a quantum computing method used to find the optimal solution of problems involving a large number of solutions, by taking advantage of properties specific to quantum physics like quantum tunneling, entanglement and superposition. Adiabatic quantum optimization is a procedure to solve a vast class of optimization problems by slowly changing the Hamiltonian of a quantum system.

By optimizing the objective function, an optimal number of resources may be assigned to the quantum computing system. Thereby, minimizing the resource wastage.

Thus, the present disclosure demonstrates how the increasing volume of data can be processed in real time using quantum processors with minimal resources. The present disclosure can do a faster processing of data and may provide more accurate patterns in real time. Therefore, the present disclosure effectively utilizes the fast-processing capabilities of quantum computers for processing huge volume of data.

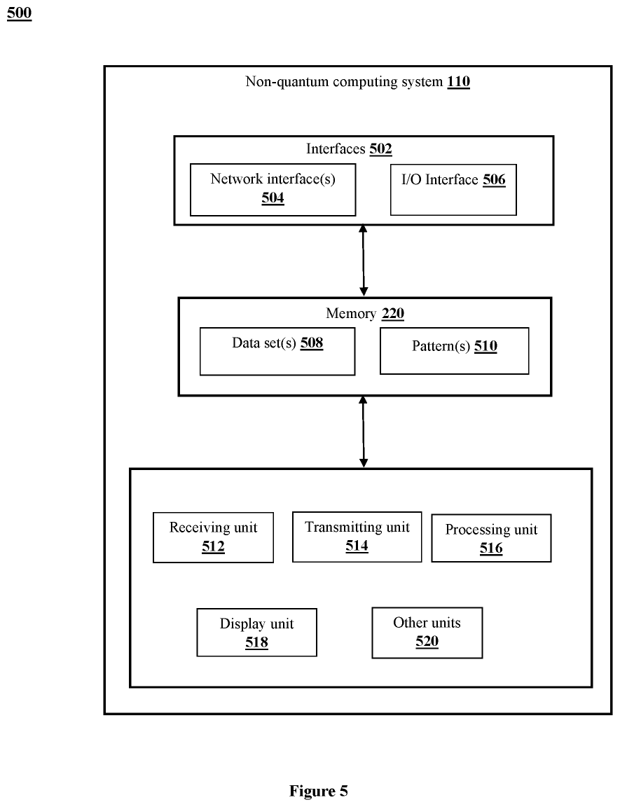

In another non-limiting embodiment of the present disclosure, the non-quantum computing system 110 may comprise various other hardware components such as various interfaces 502, the memory 220, and various units or means as shown in FIG. 5. The units may comprise a receiving unit 512, a transmitting unit 514, a processing unit 516, a display unit 518, and other units 520. The other units 520 may comprise a retrieving unit, a generating unit, an identifying unit etc. In an embodiment, the units 512-520 may be dedicated hardware units capable of executing one or more instructions stored in the memory 220 for performing various operations of the non-quantum computing system 110. In another embodiment, the units 512-520 may be software modules stored in the memory 220 which may be executed by the at least one processor 210 for performing the operations of the non-quantum computing system 110.

The interfaces 502 may include a variety of software and hardware interfaces, for example, a web interface, a graphical user interface, an input device-output device (I/O) interface 506, an access network interface 504 and the like. The I/O interfaces 506 may allow the non-quantum computing system 110 to interact with devices directly or through other devices. The access network interface 504 may allow the non-quantum computing system 110 to interact with the one or more content sources 130 and the quantum computing system 120 via the networks 140, 150.

The memory 220 may comprise various types of data 508 (such as one or more datasets, one or more processed datasets), one or more patterns 510 (i.e., at least one first intermediary pattern and at least one final pattern/cluster). The memory 220 may further store one or more instructions executable by the at least one non-quantum processor 210.

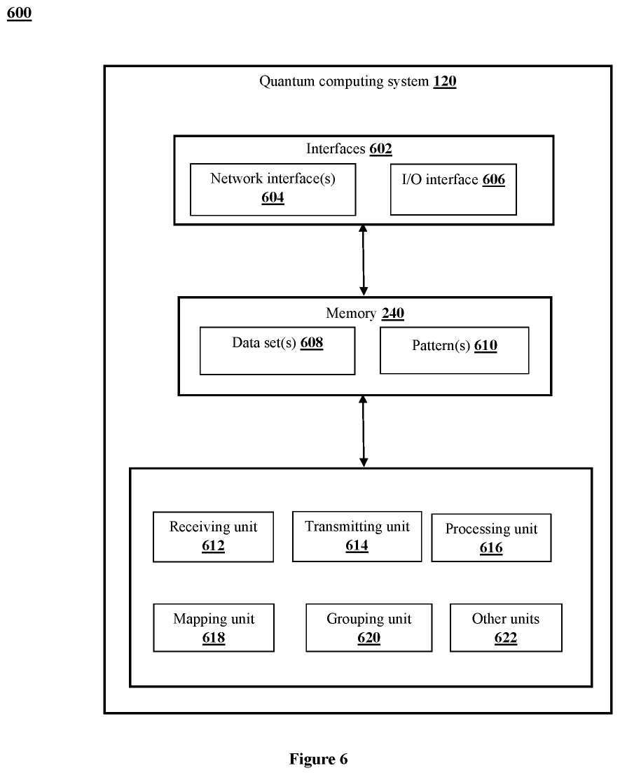

In yet another non-limiting embodiment of the present disclosure, the quantum computing system 120 may comprise various other hardware components such as various interfaces 602, the memory 240, and various units or means as shown in FIG. 6. The units may comprise a receiving unit 612, a transmitting unit 614, a processing unit 616, a mapping unit 618, a grouping unit 620, and other units 622. The other units 622 may comprise a generating unit, an identifying unit etc. In an embodiment, the units 612-622 may be dedicated hardware units capable of executing one or more instructions stored in the memory 240 for performing various operations of the quantum computing system 120. In another embodiment, the units 612-622 may be software modules stored in the memory 240 which may be executed by the at least one processor 230 for performing the operations of the non-quantum computing system 120.

The interfaces 602 may include a variety of software and hardware interfaces, for example, a web interface, a graphical user interface, an input device-output device (I/O) interface 606, an access network interface 604 and the like. The I/O interfaces 606 may allow the quantum computing system 120 to interact with devices directly or through other devices. The access network interface 604 may allow the quantum computing system 120 to interact with the non-quantum computing system 110 via the network 140.

The memory 240 may comprise various types of data such as one or more datasets 608, one or more patterns 610 (i.e., at least one second intermediary pattern, at least one second intermediary pattern, and at least one final pattern/cluster). The memory may further store one or more instructions executable by the at least one non-quantum processor 210.

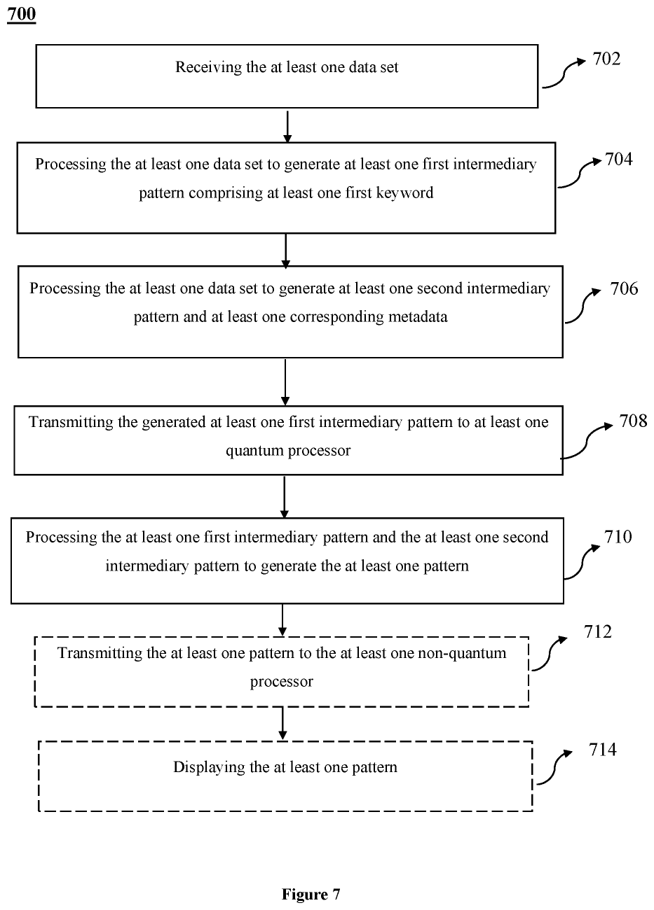

Referring now to FIG. 7, a flowchart is described illustrating an exemplary method 700 for generating at least one pattern from at least one data set, according to an embodiment of the present disclosure. The method 700 is merely provided for exemplary purposes, and embodiments are intended to include or otherwise cover any methods or procedures for generating at least one pattern from at least one data set.

The method 700 may include, at block 702, receiving the at least one data set. The at least one data set may be received by at least one non-quantum processor 210 from one or more data sources 130. The at least one non-quantum processor 210 may transmit the received at least one data set to at least one quantum processor 230. Thus, the at least one quantum processor 210 may receive the at least one data set from the at least one non-quantum processor 210. The operations of block 702 may be performed by the at least one processors 210, 230 or by the receiving units 512, 612.

At block 704, the method 700 may include processing the at least one received data set to generate at least one first intermediary pattern. The at least one first intermediary pattern may comprise at least one first keyword. For example, the at least one non-quantum processor 210 may be configured to process the at least one received data set to generate the at least one first intermediary pattern. The operations of block 704 may also be performed by the processing unit 516 of FIG. 5.

In one non-limiting embodiment of the present disclosure, the operation of block 704 i.e., processing the at least one data set to generate at least one first intermediary pattern may comprise retrieving a set of at least zero pre-defined keywords. For example, the at least one non-quantum processor 210 of FIG. 2 may be configured to retrieving the set of at least zero pre-defined keywords. This operation may also be performed by the retrieving unit 520 in conjunction with the processing unit 516 of FIG. 5. The processing of the at least one data set to generate at least one first intermediary pattern may further comprise processing the at least one data set by removing stop words from the at least one data set to generate at least one processed data set comprising at least one keyword. For example, the at least one non-quantum processor 210 of FIG. 2 or the processing unit 516 of FIG. 5 may be configured to process the at least one data set by removing the stop words from the at least one data set to generate the at least one processed data set comprising the at least one keyword.

In another non-limiting aspect of the present disclosure, processing the at least one data set to generate at least one first intermediary pattern may further comprise generating the at least one first intermediary pattern comprising at least one first keyword by identifying at least one unique keyword in the at least one processed data set and the set of at least zero pre-defined keywords, where the at least one unique keyword is the at least one first keyword. For example, the at least one non-quantum processor 210 of FIG. 2 may be configured to generate the at least one first intermediary pattern comprising the at least one first keyword by identifying the at least one unique keyword in the at least one processed data set and the set of at least zero pre-defined keywords. This operation may also be performed by the generating unit 520 in conjunction with the processing unit 516.

At block 706, the method 700 may include processing the at least one data set to generate at least one second intermediary pattern and at least one corresponding metadata. For example, the at least one quantum processor 230 of FIG. 2 or the processing unit 616 of FIG. 6 may be configured to process the at least one data set to generate the at least one second intermediary pattern and the at least one corresponding metadata.

At block 708, the method 700 may include transmitting the generated at least one first intermediary pattern to the at least one quantum processor 230. For example, the at least one non-quantum processor 210 of FIG. 2 or the transmitting unit 514 of FIG. 5 may be configured to transmit the generated at least one first intermediary pattern to the at least one quantum processor 230.

At block 710, the method 700 may include processing the at least one first intermediary pattern and the at least one second intermediary pattern to generate the at least one pattern. For example, the at least one quantum processor 230 of FIG. 2 or the processing unit 616 of FIG. 6 may be configured to process the at least one first intermediary pattern and the at least one second intermediary pattern to generate the at least one pattern.

In one non-limiting embodiment of the present disclosure, the operation of block 710 i.e., processing the at least one first intermediary pattern and the at least one second intermediary pattern to generate the at least one pattern may comprise mapping the at least one first keyword of the at least one first intermediary pattern with the at least one metadata corresponding to the at least one second intermediary pattern to identify at least one correlation between the at least one first intermediary pattern and the at least one second intermediary pattern. For example, the at least one quantum processor 230 of FIG. 2 or the mapping unit 618 in conjunction with the processing unit 616 of FIG. 6 may be configured to map the at least one first keyword of the at least one first intermediary pattern with the at least one metadata corresponding to the at least one second intermediary pattern to identify at least one correlation between the at least one first intermediary pattern and the at least one second intermediary pattern.

In another non-limiting embodiment of the present disclosure, the operation of block 710 i.e., processing the at least one first intermediary pattern and the at least one second intermediary pattern to generate the at least one pattern may further comprise grouping one or more of the at least one first intermediary pattern with one or more of the at least one second intermediary pattern to generate the at least one pattern based on the at least one correlation. For example, the at least one quantum processor 230 of FIG. 2 or the grouping unit 620 in conjunction with the processing unit 616 of FIG. 6 may be configured to group the one or more of the at least one first intermediary pattern with one or more of the at least one second intermediary pattern to generate the at least one pattern based on the at least one correlation.

In one non-limiting embodiment of the present disclosure, the method 700 may further comprise transmitting the at least one pattern to the at least one non-quantum processor 210. For example, the at least one quantum processor 210 of FIG. 2 or the transmitting unit 614 of FIG. 6 may be configured to transmit the at least one pattern to the at least one non-quantum processor 210.

In another non-limiting embodiment of the present disclosure, the method 700 may further comprise displaying the at least one pattern. For example, the at least one non-quantum processor 230 of FIG. 2 or the display unit 518 of FIG. 5 may be configured to display the at least one pattern.

In one non-limiting embodiment of the present disclosure, the at least one metadata corresponding to the at least one second intermediary pattern may comprise at least one second keyword and the operation of identifying at least one correlation between the at least one first intermediary pattern and the at least one second intermediary pattern may comprise mapping the at least one first keyword with the at least one second keyword and identifying the at least one correlation based on similarity between the at least one first keyword and the at least one second keyword. For example, the at least one quantum processor 230 of FIG. 2 or the mapping unit 618 of FIG. 6 may be configured to map the at least one first keyword with the at least one second keyword. Further, the at least one quantum processor 230 of FIG. 2 or an identifying unit may be configured to identify the at least one correlation based on similarity between the at least one first keyword and the at least one second keyword.

In one non-limiting embodiment of the present disclosure, the processing the at least one data set to generate at least one first intermediary pattern and processing the at least one data set to generate at least one second intermediary pattern are performed simultaneously. For example, the operations of blocks 704 and 706 may be performed simultaneously.

In one non-limiting embodiment of the present disclosure, the at least one first intermediary pattern and the at least one second intermediary pattern may be in the form of a cluster or a key string or a combination thereof.

The above method may be described in the general context of computer executable instructions. Generally, computer executable instructions can include routines, programs, objects, components, data structures, procedures, modules, and functions, which perform specific functions or implement specific abstract data types.

The order in which the various operations of the methods are described is not intended to be construed as a limitation, and any number of the described method blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s), including, but not limited to the processors 210, 230 of FIG. 2 and the various units of FIGS. 5-6. Generally, where there are operations illustrated in Figures, those operations may have corresponding counterpart means-plus-function components.

It may be noted here that the subject matter of some or all embodiments described with reference to FIGS. 1-6 may be relevant for the method and the same is not repeated for the sake of brevity.

In a non-limiting embodiment of the present disclosure, one or more non-transitory computer-readable media may be utilized for implementing the embodiments consistent with the present disclosure. A computer-readable media refers to any type of physical memory (such as the memory 220, 240) on which information or data readable by a processor may be stored. Thus, a computer-readable media may store one or more instructions for execution by the at least one processor 210, 230, including instructions for causing the at least one processor 210, 230 to perform steps or stages consistent with the embodiments described herein. The term “computer-readable media” should be understood to include tangible items and exclude carrier waves and transient signals. By way of example, and not limitation, such computer-readable media can comprise Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Thus, certain aspects may comprise a computer program product for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

The various illustrative logical blocks, modules, and operations described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may include a microprocessor, but in the alternative, the processor may include any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

As used herein, a phrase referring to “at least one” or “one or more” of a list of items refers to any combination of those items, including single members. As an example, “at least one of: a, b, or c” is intended to cover: a, b, c, a-b, a-c, b-c, and a-b-c. The terms “a”, “an” and “the” mean “one or more”, unless expressly specified otherwise.

The terms “an embodiment”, “embodiment”, “embodiments”, “the embodiment”, “the embodiments”, “one or more embodiments”, “some embodiments”, and “one embodiment”, “other embodiment”, “yet another embodiment”, “non-limiting embodiment” mean “one or more (but not all) embodiments of the disclosure(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

A description of an embodiment with several components in communication with each other does not imply that all such components are required. On the contrary, a variety of optional components are described to illustrate the wide variety of possible embodiments of the disclosed methods and systems.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the appended claims.

1. A method of generating at least one pattern from at least one data set, the method comprising:
receiving, by at least one non-quantum processor and at least one quantum processor, the at least one data set;
processing, by the at least one non-quantum processor, the at least one data set to generate at least one first intermediary pattern comprising at least one first keyword;
processing, by the at least one quantum processor, the at least one data set to generate at least one second intermediary pattern and at least one corresponding metadata;
transmitting, by the at least one non-quantum processor, the generated at least one first intermediary pattern to the at least one quantum processor; and
processing, by the at least one quantum processor, the at least one first intermediary pattern and the at least one second intermediary pattern to generate the at least one pattern, wherein processing the at least one first intermediary pattern and the at least one second intermediary pattern to generate the at least one pattern comprises:
mapping the at least one first keyword of the at least one first intermediary pattern with the at least one metadata corresponding to the at least one second intermediary pattern to identify at least one correlation between the at least one first intermediary pattern and the at least one second intermediary pattern; and
grouping one or more of the at least one first intermediary pattern with one or more of the at least one second intermediary pattern to generate the at least one pattern based on the at least one correlation.

2. The method as claimed in claim 1, wherein the processing the at least one data set to generate at least one first intermediary pattern and processing the at least one data set to generate at least one second intermediary pattern are performed simultaneously.

3. The method as claimed in claim 1, wherein the at least one first intermediary pattern and the at least one second intermediary pattern is in the form of a cluster or a key string or a combination of the cluster and the key string.

4. The method as claimed in claim 1, further comprising:
transmitting, by the at least one quantum processor, the at least one pattern to the at least one non-quantum processor; and
displaying, by the at least one non-quantum processor, the at least one pattern.

5. The method as claimed in claim 1, wherein the at least one metadata corresponding to the at least one second intermediary pattern comprises at least one second keyword; and
wherein identifying at least one correlation between the at least one first intermediary pattern and the at least one second intermediary pattern comprises:
mapping the at least one first keyword with the at least one second keyword; and
identifying the at least one correlation based on similarity between the at least one first keyword and the at least one second keyword.

6. The method as claimed in claim 1, wherein processing the at least one data set to generate at least one first intermediary pattern comprises:
retrieving a set of at least zero pre-defined keywords;
processing the at least one data set by removing stop words from the at least one data set to generate at least one processed data set comprising at least one keyword; and
generating the at least one first intermediary pattern comprising at least one first keyword by:
identifying at least one unique keyword in the at least one processed data set and the set of at least zero pre-defined keywords, wherein the at least one unique keyword is the at least one first keyword.

7. A system for generating at least one pattern from at least one data set, the system comprising:
at least one quantum processor; and
at least one non-quantum processor operatively coupled to the at least one quantum processor and configured to:
receive the at least one data set;
process the at least one data set to generate at least one first intermediary pattern comprising at least one first keyword; and
transmit the generated at least one first intermediary pattern to the at least one quantum processor,
said at least one quantum processor configured to:
receive the at least one data set;
receive the at least one first intermediary pattern;
process the at least one data set to generate at least one second intermediary pattern and at least one corresponding metadata; and
process the at least one first intermediary pattern and the at least one second intermediary pattern to generate the at least one pattern by:
mapping the at least one first keyword of the at least one first intermediary pattern with the at least one metadata corresponding to the at least one second intermediary pattern to identify at least one correlation between the at least one first intermediary pattern and the at least one second intermediary pattern; and
grouping one or more of the at least one first intermediary pattern with one or more of the at least one second intermediary pattern to generate the at least one pattern based on the at least one correlation.

8. The system as claimed in claim 7, wherein the at least one non-quantum processor and the at least one quantum processor are configured to process the at least one data set simultaneously.

9. The system as claimed in claim 7, wherein the at least one first intermediary pattern and the at least one second intermediary pattern is in the form of a cluster or a key string or a combination of the cluster and the key string.

10. The system as claimed in claim 7, wherein the at least one quantum processor is further configured to transmit the at least one pattern to the at least one non-quantum processor; and
wherein the at least one non-quantum processor is further configured to display the at least one pattern.

11. The system as claimed in claim 7, wherein the at least one metadata corresponding to the at least one second intermediary pattern comprises at least one second keyword; and
wherein the at least one quantum processor is configured to identify at least one correlation between the at least one first intermediary pattern and the at least one second intermediary pattern by:
mapping the at least one first keyword with the at least one second keyword; and
identifying the at least one correlation based on similarity between the at least one first keyword and the at least one second keyword.

12. The system as claimed in claim 7, wherein the at least one non-quantum processor is configured to generate at least one first intermediary pattern by:
retrieving a set of at least zero pre-defined keywords;
processing the at least one data set by removing stop words from the at least one data set to generate at least one processed data set comprising at least one keyword; and
generating the at least one first intermediary pattern comprising at least one first keyword by:
identifying at least one unique keyword in the at least one processed data set and the set of at least zero pre-defined keywords, wherein the at least one unique keyword is the at least one first keyword.
